(19) United States
(12) Patent Application Publication
(10) Pub. No.: US 2013/0080716 A1
(43) Pub. Date: Mar. 28, 2013

(54) CONTROLLER, MEMORY SYSTEM, AND INSPECTION METHOD

(71) Applicant: Masahiro TAMURA, Kanagawa (JP)

(72) Inventor: Masahiro TAMURA, Kanagawa (JP)

(73) Assignee: Kabushiki Kaisha Toshiba, Tokyo (JP)

(21) Appl. No.: 13/526,751

(22) Filed: Jun. 19, 2012

(30) Foreign Application Priority Data
Sep. 26, 2011 (JP) 2011-208442

(51) Int. Cl. G06F 12/00

(52) U.S. Cl. 711/154; 711/E12.001

(57) ABSTRACT

According to embodiments, a controller includes a read inspection unit, an inspection block setting unit, and a timing determining unit. The read inspection unit performs a read inspection for determining whether to perform rewriting of valid data to a block in which the valid data is stored among a plurality of blocks included in a nonvolatile memory. The inspection block setting unit generates an inspection block by writing inspection pattern data having a threshold as high as possible in at least one of the blocks included in the nonvolatile memory. The timing determining unit determines a timing of performing the read inspection by the read inspection unit based on the number of inverted bits that occurs in inspection pattern data written in the inspection block.

### CROSS-REFERENCE TO RELATED APPLICATIONS

This application is based upon and claims the benefit of priority from Japanese Patent Application No. 2011-208442, filed on Sep. 26, 2011; the entire contents of which are incorporated herein by reference.

### FIELD

Embodiments described herein relate generally to a controller, a memory system, and an inspection method.

### BACKGROUND

As memory systems used in a computer system, SSDs (Solid State Drive), on which a memory chip including a NAND-type flash memory is mounted, attract attention. SSDs have advantages, such as high speed and lightweight, compared with magnetic disk devices.

In flash memories including a NAND type, stored data is lost due to discharge of charges stored in a floating gate electrode over time, so that there are constraints that a data retention period (data retention) is limited. Therefore, in order to ensure stored data, the stored data needs to be rewritten before the data retention passes.

### BRIEF DESCRIPTION OF THE DRAWINGS

FIG. 1 is a diagram illustrating a configuration example of an SSD according to a first embodiment of the present invention;

FIG. 2 is a circuit diagram illustrating a configuration example of one block included in a memory cell array;

FIG. 3 is a diagram illustrating an example of a threshold distribution in a four-value data storing method of storing 2 bits in one memory cell transistor MT;

FIG. 4 is a diagram explaining a data configuration example of a logical-physical translation table in the first embodiment;

FIG. 5 is a diagram explaining an operation of the SSD in the first embodiment;

FIG. 6 is a diagram illustrating a configuration example of an SSD according to a second embodiment;

FIG. 7 is a diagram explaining a data configuration example of a logical-physical translation table in the second embodiment;

FIG. 8 is a diagram explaining an inspection block set by an inspection block setting unit;

FIG. 9 is a diagram explaining an operation relating to a read inspection of the SSD in the second embodiment;

FIG. 10 is a flowchart explaining an operation relating to data writing of the SSD in the second embodiment;

FIG. 11 is a perspective view illustrating an outline of a personal computer; and

FIG. 12 is a diagram illustrating a function configuration example of the personal computer.

### DETAILED DESCRIPTION

According to embodiments, a controller includes a read inspection performing unit, an inspection block setting unit, and a timing determining unit. The read inspection performing unit performs a read inspection for determining whether to perform rewriting of valid data to a block in which the valid data is stored among a plurality of blocks included in a nonvolatile memory. The inspection block setting unit generates an inspection block by writing inspection pattern data having a threshold as high as possible in at least one of the blocks included in the nonvolatile memory. The timing determining unit determines a timing of performing the read inspection by the read inspection performing unit based on the number of inverted bits that occurs in inspection pattern data written in the inspection block.

A controller, a memory system, and an inspection method according to the embodiments of the present invention will be explained below in detail with reference to the accompanying drawings. The present invention is not limited to these embodiments. In the embodiments, an SSD including a NAND-type flash memory is explained as an example of the memory system, however, a flash memory is not limited to a NAND type.

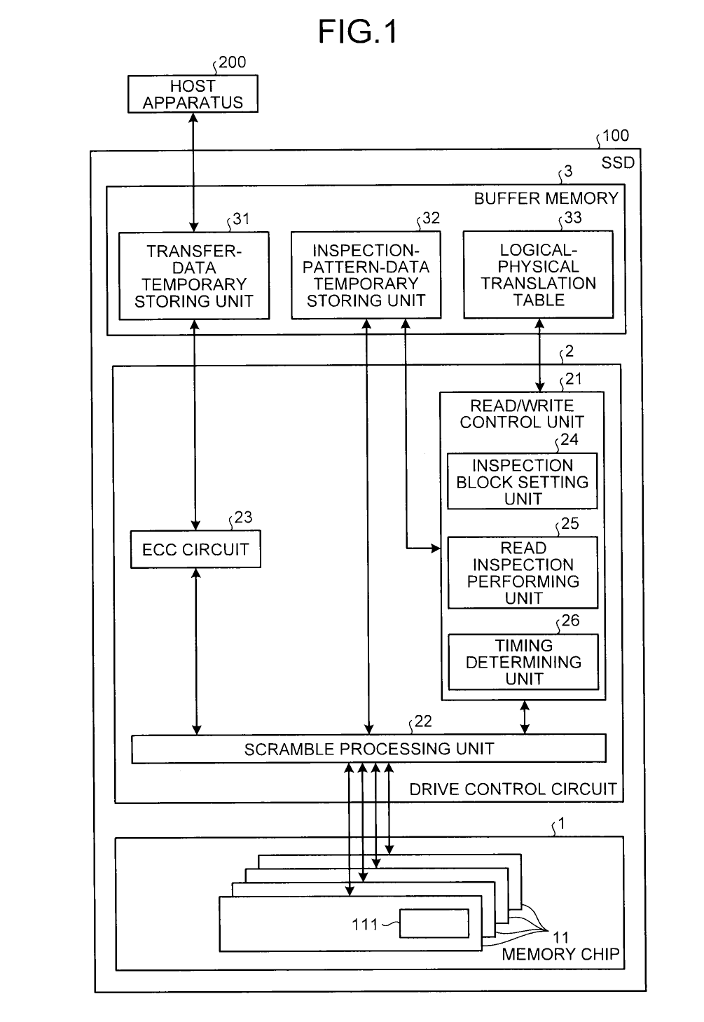

FIG. 1 is a diagram illustrating a configuration example of an SSD according to a first embodiment of the present invention. As shown in FIG. 1, an SSD 100 is connected to a host apparatus 200, such as a personal computer, with a communication interface of an ATA (Advanced Technology Attachment) standard or the like to function as an external storage device of the host apparatus 200. A read/write request that the SSD 100 receives from the host apparatus 200 includes a top address of a subject to be accessed, which is defined by LBA (Logical Block Addressing), and a sector size indicating a range of a region of the subject to be accessed. The communication interface is not limited to the ATA standard and various communication interface standards, such as SAS (Serial Attached SCSI) and PCIe (PCI Express), can be employed.

The SSD 100 includes a NAND memory 1, a drive control circuit 2 that performs data transfer between the host apparatus 200 and the NAND memory 1, and a buffer memory 3.

The NAND memory 1 is configured to include a plurality of (four in this embodiment) memory chips 11 each operating independently. Each of the memory chips 11 includes a memory cell array 111 that stores write data from the host apparatus 200.

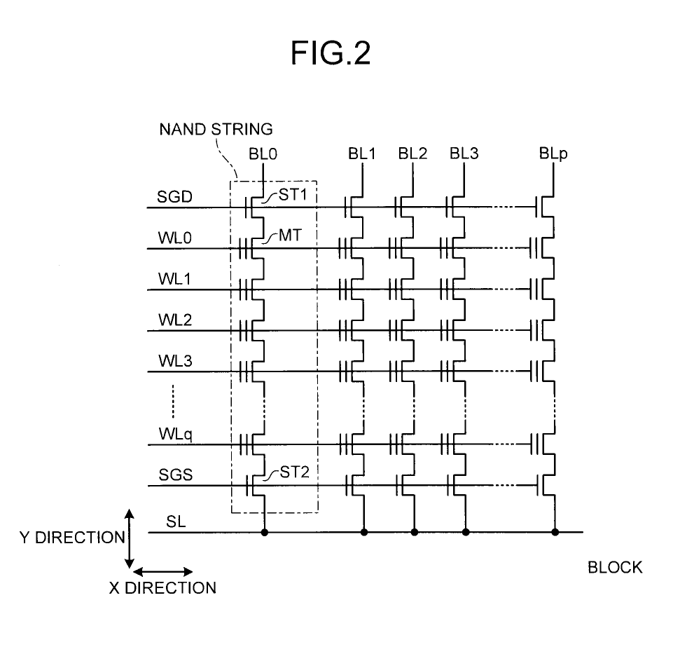

The memory cell array 111 includes a plurality of blocks as a unit of erasing. FIG. 2 is a circuit diagram illustrating a configuration example of one block included in the memory cell array 111. As shown in FIG. 2, each block includes (m+1) number of NAND strings arrayed in order along an X direction (m is an integer of 0 or more). In select transistors ST1 included in the (m+1) number of NAND strings, drains are connected to bit lines BL0 to BLp, respectively, and gates are connected in common to a select gate line SGD. Moreover, in select transistors ST2, sources are connected in common to a source line SL and gates are connected in common to a select gate line SGS.

Each memory cell transistor MT is composed of a MOSFET (metal oxide semiconductor field effect transistor) having a stacked gate structure formed on a semiconductor substrate. The stacked gate structure includes a charge storage layer (floating gate electrode) formed on the semiconductor substrate via a gate dielectric film and a control gate electrode formed on the charge storage layer via an inter-gate dielectric film. In the memory cell transistor MT, a threshold voltage changes according to the number of electrons stored in the floating gate electrode and data is stored according to the difference in this threshold voltage. The memory cell transistor MT may be configured to store 1 bit or may be configured to store multiple values (data of 2 bits or more).

In each NAND string, (n+1) number of the memory cell transistors MT are arranged between the source of the select transistor ST1 and the drain of the select transistor ST2 so that current paths thereof are connected in series. The control gate electrodes of the memory cell transistors MT are connected to word lines WL0 to WLq, respectively, in order from the memory cell transistor MT located on the most drain side. Therefore, the drain of the memory cell transistor MT connected to the word line WL0 is connected to the source of the select transistor ST1 and the source of the memory cell transistor MT connected to the word line WLq is connected to the drain of the select transistors ST2.

Each of the word lines WL0 to WLq connects the control gate electrodes of the memory cell transistors MT in common between the NAND strings in a block. That is, the control gate electrodes of the memory cell transistors MT on the same row in a block are connected to the same word line WL. The (m+1) number of the memory cell transistors MT connected to the same word line WL are defined as 1 page and data writing and data reading are performed for each page.

Moreover, each of the bit lines BL0 to BLp connects the drains of the select transistors ST1 in common between blocks. That is, the NAND strings on the same column in a plurality of blocks are connected to the same bit line BL.

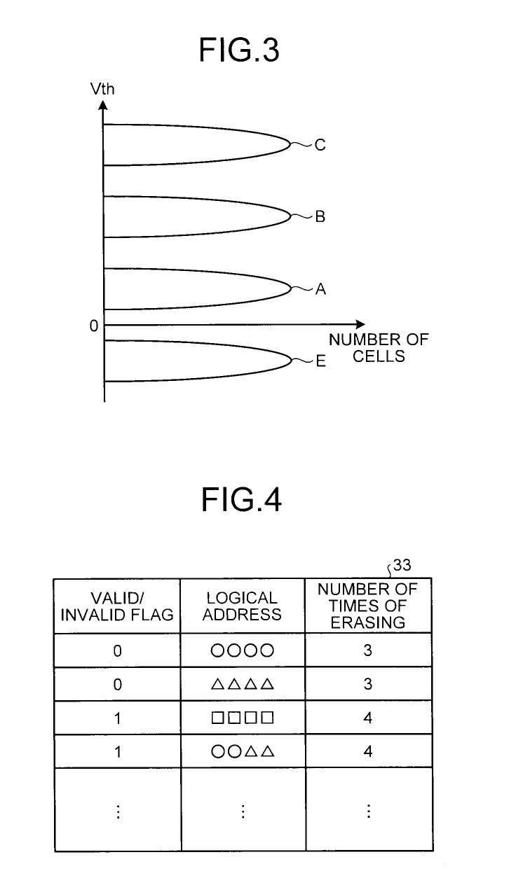

FIG. 3 illustrates an example of a threshold distribution in a four-value data storing method of storing 2 bits in one memory cell transistor MT. In the four-value data storing method, any one of four-value data “xy” defined by upper page data “x” and lower page data “y” can be stored in the memory cell transistor MT. For example, data “11”, “10”, “01”, and “00” are allocated to this four-value data “xy” in order of the threshold voltage of the memory cell transistor MT. The data “11” indicates that the threshold voltage of the memory cell transistor MT is negative, that is, the erased state.

Charges stored in a floating gate electrode are discharged over time, so that, in the memory cell transistor MT in a state other than the erased state, a threshold voltage gradually decreases as time passes and, as a result, a written value cannot be read out in some cases. Therefore, processing of rewriting data is needed before a period (data retention), after which a written value cannot be read out, passes.

As a technology of performing rewriting, there is a technology in which a time at which reading is performed last is stored as internal managing data for all blocks and a read inspection of data in the blocks is performed every time a predetermined time (for example, one week) passes as an integration time (power-on time), during which the power is on, after the last reading. In the following, this technology is described as a technology in a comparison example. According to the technology in the comparison example, when the inspection result of a read inspection is no good, rewriting of data stored in a target block is performed.

However, data retention is shortened according to increase in the number of times of erasing. According to the technology in the comparison example, an inspection period is fixed to an interval by assuming a state in which the number of times of erasing approaches a product lifetime. Therefore, in a period in which the number of times of erasing is small, the inspection interval becomes short unnecessarily, so that there is a problem that thresholds of neighboring memory cell transistors MT change due to read disturb.

Moreover, even when the power is off, charges are discharged from a floating gate electrode. According to the technology in the comparison example, because only the elapsed time during which the power is on is considered, there are concerns that rewriting may not be performed before loss of data when the power-off state continues for a long time.

On the contrary, in order to reduce frequency of a read inspection for a block (hereinafter, active block) in which valid data, such as write data from the host apparatus 200 and internal managing data, is stored, in the first embodiment, a dedicated block (hereinafter, inspection block) for performing a read inspection is prepared aside from an active block and it is determined whether to perform a read inspection on an active block based on the inspection result of a read inspection of inspection pattern data written in the inspection block. Moreover, a read inspection of the inspection pattern data is performed even when the power is on so that rewriting can be performed without waiting for a periodic read inspection of the inspection pattern data even when decrease in threshold progresses when the power is off to become a state in which data loss occurs.

Data retention tends to become short as a threshold of data is higher. Therefore, in order to detect occurrence of data loss in an active block beforehand, a value having a threshold as high as possible is used as the inspection pattern data. Consequently, the inspection pattern data loss can be caused to occur before occurrence of data loss in an active block, so that data loss in an active block can be prevented by performing a read inspection of an active block when the inspection pattern data loss is detected by a read inspection. In this embodiment, the data “00”, which is a state in which a threshold is the highest, is set as the inspection pattern data.

Returning to FIG. 1, the buffer memory 3 includes a transfer-data temporary storing unit 31 for temporarily storing transfer data between the host apparatus 200 and the NAND memory 1 and an inspection-pattern-data temporary storing unit 32 for temporarily storing the inspection pattern data. Data transmitted from the host apparatus 200 is once stored in the transfer-data temporary storing unit 31 under the control of the drive control circuit 2 and is thereafter read out from the transfer-data temporary storing unit 31 and written in the NAND memory 1. Moreover, the data stored in the NAND memory 1 is transmitted to the host apparatus 200 via the transfer-data temporary storing unit 31 under the control of the drive control circuit 2.

Moreover, in the buffer memory 3, a logical-physical translation table (address translation table) 33, which associates physical addresses in the NAND memory 1 with LBA, is stored. The logical-physical translation table 33 is described in detail later.

The buffer memory 3 is, for example, composed of a memory capable of performing a high-speed operation compared with the NAND memory 1, such as a DRAM (Dynamic Random Access Memory), an MRAM (Magnetoresistive Random Access Memory), and an FeRAM (Ferroelectric Random Access Memory).

The drive control circuit 2 includes a read/write control unit 21, a scramble processing unit 22, and an ECC circuit 23.

The read/write control unit 21 controls data writing to the NAND memory 1. In order to prevent a specific region from wearing and becoming inoperative due to occurrence of excessive bias of a distribution in the number of times of rewriting in the NAND memory 1, there is a write system called static wear leveling in which, at the time of a write request from the host apparatus 200, writing is performed on a region, in which the number of times of rewriting is small, in priority to other regions, thereby leveling the distribution in the number of times of rewriting. When the read/write control unit 21 performs data transfer from the transfer-data temporary storing unit 31 to the NAND memory 1, the read/write control unit 21 designates a block, in which the number of times of rewriting is as small as possible, as a write destination, based on the static wear leveling system. The read/write control unit 21 updates the logical-physical translation table 33 every time writing of transfer data is performed.

FIG. 4 is a diagram explaining a data configuration example of the logical-physical translation table 33 in the first embodiment. In the logical-physical translation table 33, entries are registered in ascending order of a physical address for each block. Then, each entry includes a field in which a valid/invalid flag indicating whether a block is an active block or a free block, in which valid data is not stored, is stored, a filed in which LBA as a logical address to which a top of a block is allocated is stored, and a region in which cumulative number of times of erasing is stored. The valid/invalid flag indicating valid indicates that a target block is an active block and the valid/invalid flag indicating invalid indicates that a target block is a free block. An entry in the logical-physical translation table 33 may include a field in which flag information indicating whether a block is an inspection block is stored. Moreover, in the logical-physical translation table 33, instead of registering the entries in ascending order for each block, the entries may be registered in descending order. Moreover, each entry in the logical-physical translation table 33 may include a filed in which a top physical block of a block is stored.

Moreover, the read/write control unit 21 includes an inspection block setting unit 24 that sets a free block as an inspection block and writes the inspection pattern data to the inspection block, a read inspection performing unit 25 that performs a read inspection on an active block, and a timing determining unit 26 that determines execution timing of a read inspection based on the number of inverted bits occurred in an inspection block. When the inspection block setting unit 24 writes the inspection pattern data to an inspection block, the inspection block setting unit 24 prepares the inspection pattern data as a write target in the inspection-pattern-data temporary storing unit 32. When the timing determining unit 26 counts the number of inverted bits occurred in an inspection block, the timing determining unit 26 reads out the inspection pattern data from the NAND memory 1 to the inspection-pattern-data temporary storing unit 32.

The ECC circuit 23 performs encoding and decoding of an error correction code. The error correction code is, for example, a hamming code, a BCH (Bose Chaudhuri Hocquenghem) code, a RS (Reed Solomon) code, a LDPC (Low Density Parity Check) code, or the like, and the ECC circuit 23 adds an error correction code when transfer data stored in the transfer-data temporary storing unit 31 is written in the NAND memory 1. Moreover, the ECC circuit 23 performs error correction of data based on an error correction code added to the data read out from the NAND memory 1 and stores data after error correction in the transfer-data temporary storing unit 31.

When writing data, to which an error correction code is added, to the NAND memory 1, the scramble processing unit 22 performs an exclusive OR operation on the data and random data generated by a predetermined method and writes the obtained data. For example, even when data as a write target is data in which the same value continues, the data is randomized by this processing at the time of writing, so that problems of program disturb and read disturb are eased and data reliability can be improved. In the following, processing of performing an exclusive OR operation on write data and random data is called scramble processing.

Moreover, when reading out data from the NAND memory 1, the scramble processing unit 22 performs an exclusive OR operation on the read out data and random data same as that at the time of the scramble processing to obtain data before the scramble processing and sends the obtained data to the ECC circuit 23. Processing of obtaining data before the scramble processing is called restoration processing.

The scramble processing unit 22 excludes the inspection pattern data from a target for the scramble processing. Therefore, when the inspection block setting unit 24 writes the inspection pattern data or when the timing determining unit 26 reads out the inspection pattern data, the inspection block setting unit 24 or the timing determining unit 26 issues a scramble processing invalid notification as a notification to make the scramble processing (and the restoration processing) invalid. The scramble processing unit 22 performs the scramble processing or the restoration processing when the scramble processing invalid notification is not received and does not perform the scramble processing and the restoration processing when the scramble processing invalid notification is received.

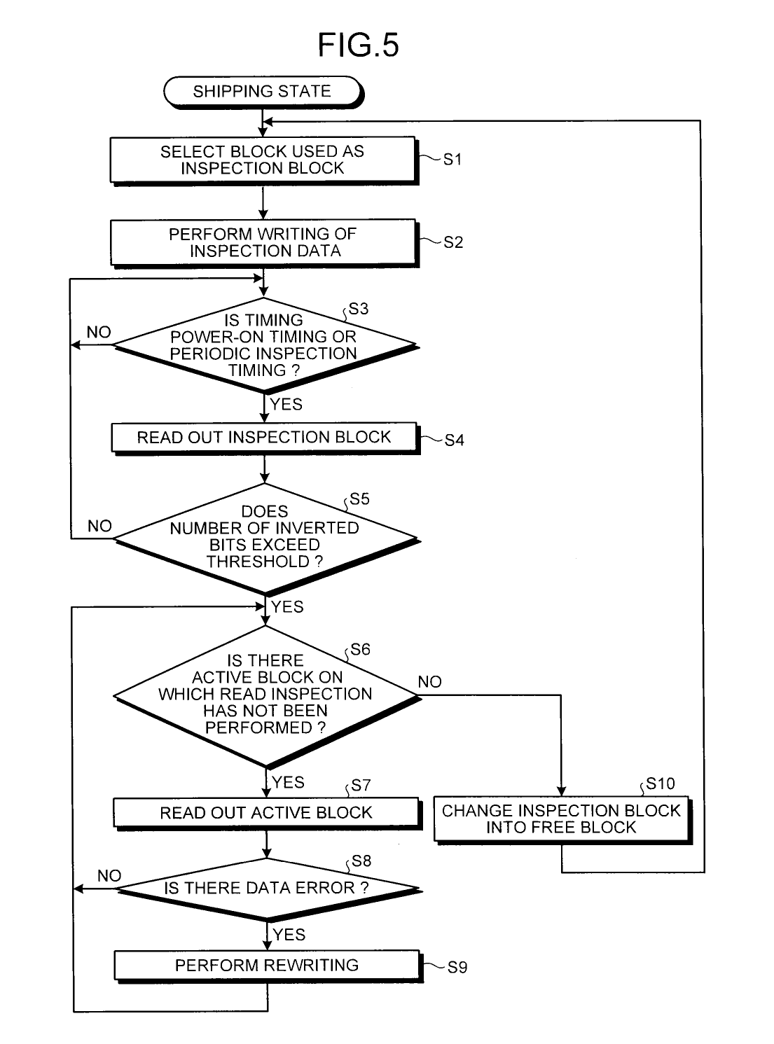

Next, an operation of the SSD 100 in the first embodiment of the present invention is explained. FIG. 5 is a diagram explaining an operation of the SSD 100 in the first embodiment.

The power is turned on from a shipping state and the operation starts. First, the inspection block setting unit 24 selects a block to be used as an inspection block from among free blocks (Step S1).

In this embodiment, it is explained that one inspection block is selected for each of the memory chips 11, however, two or more inspection blocks may be selected for each of the memory chips 11 or one or more inspection blocks may be selected for the whole NAND memory 1. When an inspection block is selected for each of the memory chips 11, the following operation is performed for each of the memory chips 11. When an inspection block is selected from the whole NAND memory 1, the following operation is performed with the blocks of the whole NAND memory 1 as a target. Each of the memory chips 11 has different data retention in some cases due to variation in a manufacturing process. The timing of a read inspection of an active block can be determined for each of the memory chips 11 by setting an inspection block for each of the memory chips 11, so that data loss can be prevented more efficiently than a case of setting an inspection block from the blocks of the whole NAND memory 1.

After Step S1, the inspection block setting unit 24 writes the inspection pattern data to the selected inspection block (Step S2). In the processing in Step S2, the inspection block setting unit 24 prepares the inspection pattern data, with which one whole block becomes the data “11”, in the inspection-pattern-data temporary storing unit 32 and asserts the scramble processing invalid notification. The scramble processing unit 22 writes the inspection pattern data stored in the inspection-pattern-data temporary storing unit 32 to the inspection block without performing the scrambling processing. After writing the inspection pattern data, the inspection block setting unit 24 deasserts the scramble processing invalid notification.

Next, the timing determining unit 26 determines whether current timing corresponds to timing at which the power is turned on or timing (periodic inspection timing) at which a predetermined time, during which the power is on, has passed after the last read inspection (Step S3). When the current timing does not correspond to any of the above timings (No in Step S3), the timing determining unit 26 performs the determination processing in Step S3 again.

When the current timing corresponds to any one (or both) of the timings (Yes in Step S3), the timing determining unit 26 reads out the inspection pattern data in the inspection block to the inspection-pattern-data temporary storing unit 32 (Step S4) and determines whether the number of inverted bits included in the read out inspection pattern data exceeds a predetermined threshold (Step S5).

In the similar manner to the writing in Step S2, when reading out the inspection pattern data, the timing determining unit 26 asserts the scramble processing invalid notification, and when reading of the inspection pattern data is finished, the timing determining unit 26 deasserts the scramble processing invalid notification.

In the determination processing in Step S5, when the number of inverted bits included in the inspection pattern does not exceed the threshold (No in Step S5), the timing determining unit 26 performs the determination processing in Step S3. When the number of inverted bits included in the inspection pattern exceeds the threshold (Yes in Step S5), the read inspection performing unit 25 performs a read inspection of an active block in the processing in Step S6 to Step S10.

Because the inspection pattern data is composed of a value having the highest threshold, bit inversion due to decrease in threshold easily occurs compared with data including a value other than the value having the highest threshold by being subjected to the scramble processing. Therefore, temporal change of bit inversion of the inspection pattern data and data written after being subjected to the scramble processing may be obtained in advance, for example, by experiments and the threshold used in the determination processing in Step S5 may be determined based on the obtained temporal change of bit inversion. For example, it is possible to obtain the number of inverted bits of the inspection pattern data at the time at which bit inversion occurs to data written after being subjected to the scramble processing to such an extent that the ECC circuit 23 cannot correct it and set the number smaller than the obtained number of inverted bits of the inspection pattern data by a predetermined number as the threshold in the determination processing in Step S5. In this manner, rewriting of an active block can be performed before an uncorrectable data error occurs in an active block.

Moreover, in this embodiment, the memory cell transistors MT configuring the memory cell array 111 each store four-value data and the inspection pattern data is set to the data “11”, so that bit inversion indicates that data stored in the memory cell transistor MT is a value other than the inspection pattern data (that is, data “11”).

In Step S6, the read inspection performing unit 25 determines whether there is an active block on which a read inspection has not been performed. When there is an active block on which a read inspection has not been performed (Yes in Step S6), the timing determining unit 26 reads out data from one of active blocks on which a read inspection has not been performed (Step S7) and determines whether there is a data error in the read out data (Step S8).

Presence or absence of a data error can be determined by checking whether the ECC circuit 23 detects and corrects an error. That is, when an error (bit inversion) is detected and the error is corrected, the read inspection performing unit 25 determines that a data error occurs, and when an error is not detected, the read inspection performing unit 25 determines that a data error does not occur.

Bit inversion may constantly occur. Therefore, in the determination processing in Step S8, instead of determining whether bit inversion occurs, a threshold of the number of inverted bits may be set in advance based on the number of inverted bits with which error correction cannot be performed by the ECC circuit 23 and, when the number of inverted bits exceeds the threshold, the processing may proceed to the processing after Yes in Step S8, and when the number of inverted bits does not exceed the threshold, the processing may proceed to the processing after No in Step S8.

When a data error occurs (Yes in Step S8), the read inspection performing unit 25 rewrites data after correction in a free block (Step S9) and performs the determination processing in Step S6. When a data error does not occur (No in Step S8), the read inspection performing unit 25 skips the processing in Step S9.

In Step S6, when there is no active block on which a read inspection has not been performed (No in Step S6), the inspection block setting unit 24 erases the inspection pattern data from the inspection block to change the inspection block into a free block (Step S10). Then, the processing moves to Step S1 and a new block to be used as an inspection block is selected from free blocks.

In this manner, according to the first embodiment in the present invention, the configuration is such that the read inspection performing unit 25 that performs a read inspection of an active block, the inspection block setting unit 24 that writes the inspection pattern data having a threshold as high as possible to set an inspection block, and the timing determining unit 26 that determines execution timing of a read inspection of an active block based on the number of inverted bits generated in the inspection pattern data written in the inspection block are included, so that frequency of a read inspection for an active block can be reduced, enabling to efficiently prevent data loss. Moreover, the effect of read disturb to an active block by a read inspection can be reduced by reducing frequency of a read inspection for an active block.

Moreover, the timing determining unit 26 is configured to count the number of inverted bits of the inspection pattern data when the power is on, so that a read inspection can be performed when the power is on.

Furthermore, the timing determining unit 26 is configured to instruct the scramble processing unit 22 to exclude the inspection pattern data from a target for the scramble processing, so that the inspection pattern data, in which decrease in threshold easily occurs compared with valid data, can be written, enabling the timing determining unit 26 to determine the timing of a read inspection in an active block at an earlier timing.

When the processing moves to Step S1 via No in Step S6, in Step S1, the read/write control unit 21 desirably refers to the logical-physical translation table 33 and selects a block, in which the number of times of writing is as large as possible among free blocks, as an inspection block. As described above, because data retention tends to become shorter as the number of times of writing is larger, the timing determining unit 26 can determine the timing of a read inspection in an active block at an earlier timing by setting a block, in which the number of times of writing is as large as possible, as an inspection block.

Moreover, in Step S9, the read inspection performing unit 25 may write data after correction in a free block selected based on the static wear leveling.

Furthermore, there is the memory cell transistor MT configured to be capable of switching between a mode (MLC mode), in which data of three or more values is stored, and a mode (SLC mode), in which data of two values is stored. In such a case, it is sufficient that an inspection block is driven in the MLC mode and data having a threshold as high as possible is set to the inspection pattern data. Consequently, even when an active block is driven in any mode, it is possible to create a situation in which bit inversion occurs easily in an inspection block compared with an active block, and as a result, data loss due to the elapse of data retention can be efficiently prevented.

According to a second embodiment, an inspection block is left even after performing a read inspection on an active block so that data loss can be prevented even with respect to an active block, which passes a read inspection at execution timing of a read inspection for an active block and is not subjected to rewriting and in which therefore the elapsed time from the time of writing becomes longer than an active block on which rewriting is performed at the execution timing of a read inspection.

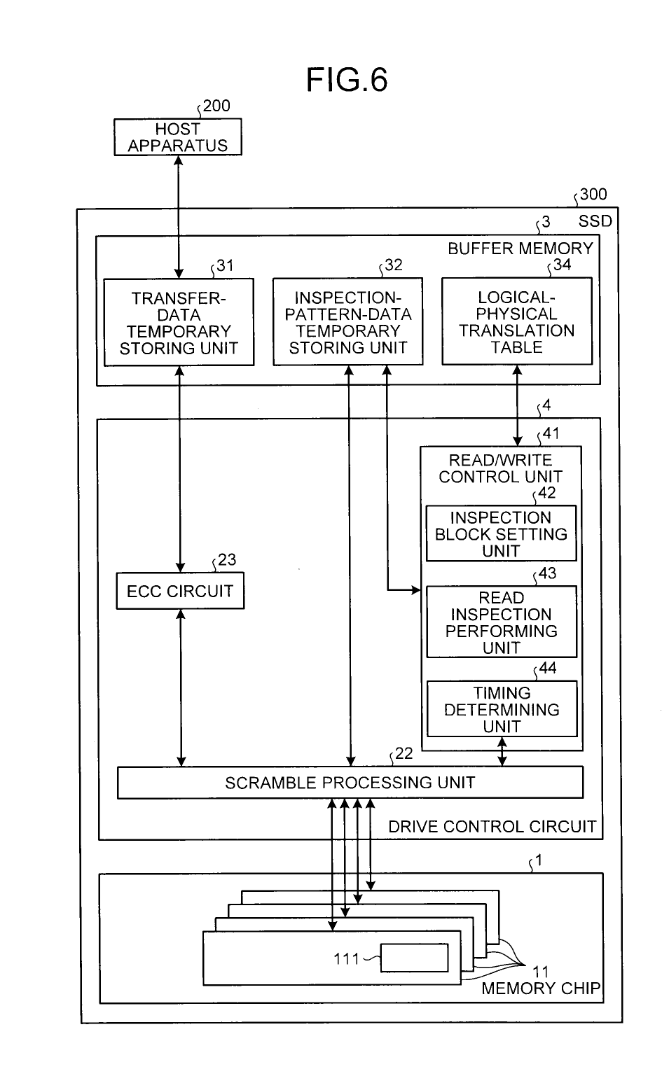

FIG. 6 is a diagram illustrating a configuration example of an SSD according to the second embodiment. As shown in FIG. 6, an SSD 300 includes the NAND memory 1, the buffer memory 3, and a drive control circuit 4. In this embodiment, components same as those in the first embodiment are denoted by the same reference numerals and overlapping explanation is omitted.

The NAND memory 1 includes a plurality of (four in this embodiment) memory chips 11 each including the memory cell array 111.

The transfer-data temporary storing unit 31 and the inspection-pattern-data temporary storing unit 32 are included in the buffer memory 3. Moreover, in the buffer memory 3, a logical-physical translation table 34 is stored. Details of the logical-physical translation table 34 will be explained later.

The drive control circuit 4 includes a read/write control unit 41, the scramble processing unit 22, and the ECC circuit 23.

The read/write control unit 41 controls data writing to the NAND memory 1. There is a method called dynamic wear leveling in which when there is a difference in the number of times of erasing between blocks, data stored in a block, in which the number of times of erasing is small, is copied into a block, in which the number of times of erasing is large, to positively change a block, in which the number of times of erasing is small, into a free block, thereby reducing variation in the number of times of erasing between blocks as much as possible. The read/write control unit 41 performs writing of data based on the static wear leveling and performs copying of data in an active block based on the dynamic wear leveling. The read/write control unit 41 updates the logical-physical translation table 34 every time writing (including copying) of transfer data is performed.

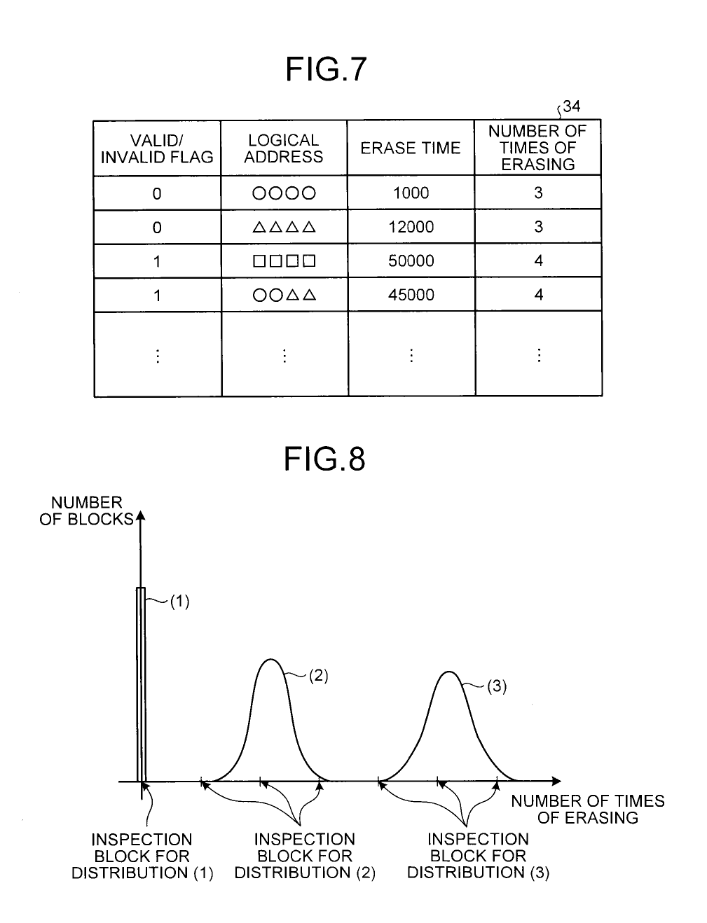

FIG. 7 is a diagram explaining a data configuration example of the logical-physical translation table 34 in the second embodiment. In the logical-physical translation table 34, entries are registered in ascending order of a physical address for each block. Then, each entry includes a field in which a valid/invalid flag indicating whether a block is an active block or a free block, in which valid data is not stored, is stored, a filed in which LBA as a logical address to which a top of a block is allocated is stored, a region in which an erase time is stored, and a region in which cumulative number of times of erasing is stored. The erase time is a time at which erasing is performed when the power is on.

Moreover, the read/write control unit 41 includes an inspection block setting unit 42 that sets an inspection block, a read inspection performing unit 43 that performs a read inspection on an active block, and a timing determining unit 44 that determines execution timing of a read inspection of an active block. Because the read/write control unit 41 performs the dynamic wear leveling, the distribution of the number of times of erasing between blocks becomes narrow compared with the case where the dynamic wear leveling is not performed. The inspection block setting unit 42 sets an inspection block so that the number of times of erasing does not deviate from the distribution of the number of times of erasing of active blocks. Specifically, the inspection block setting unit 42 can prevent a data error, whose error cannot be corrected, from occurring even in an active block of any number of times of erasing by preparing a plurality of inspection blocks of different number of times of erasing.

FIG. 8 is a diagram explaining inspection blocks set by the inspection block setting unit 42. In FIG. 8, the vertical axis indicates the number of blocks for each active block and the horizontal axis indicates the number of times of erasing. At the time when data writing is performed immediately after shipping, the number of times of erasing of all active blocks is zero (distribution (1)) and one inspection block, in which the number of times of erasing is zero, is set. When the average number of times of erasing of blocks increases and the number of times of erasing of active blocks is distributed as a distribution (2), a plurality of (three in this embodiment) inspection blocks are set to cover the distribution (2). Even if the average number of times of erasing of blocks further increases, the range of the distribution is kept constant due to the effect of the dynamic wear leveling. Even when the average number of times of erasing further increases from the state of the distribution (2) and the number of times of erasing of active blocks is distributed as a distribution (3), a plurality of (three in this embodiment) inspection blocks are set to cover the distribution (3).

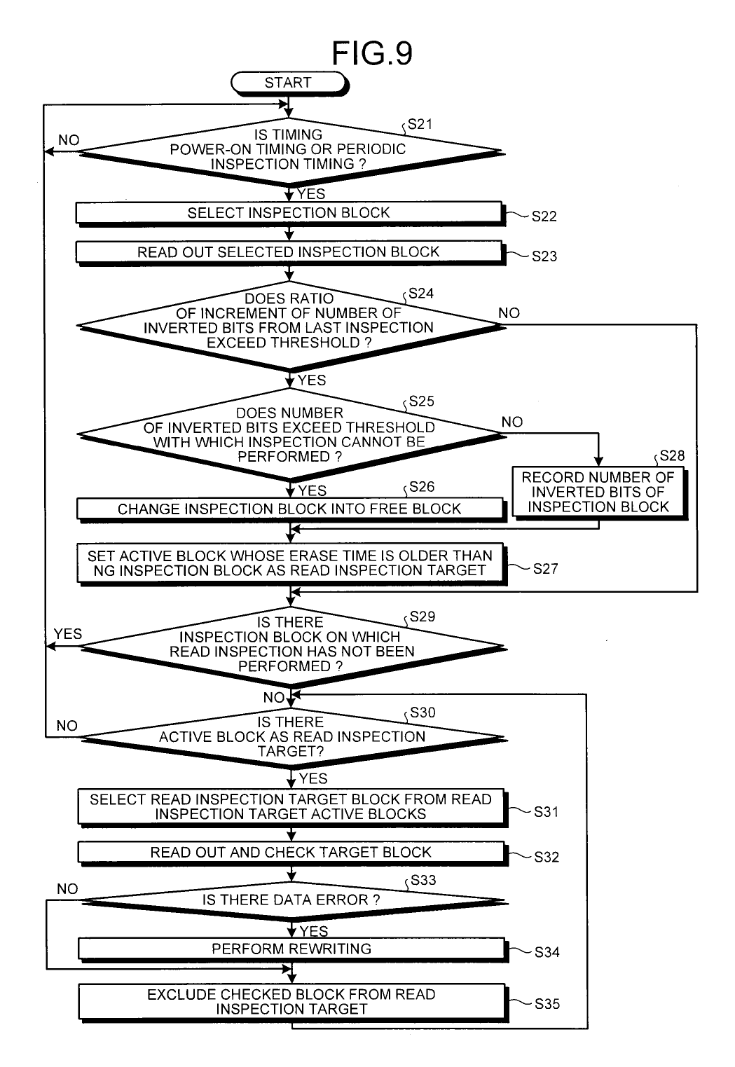

FIG. 9 is a diagram explaining an operation relating to a read inspection of the SSD 300 in the second embodiment. In this embodiment, it is explained that an inspection block is set individually for each of the memory chips 11. That is, the operation relating to a read inspection and the operation relating to data writing to be described later are performed individually for each of the memory chips 11. An inspection block may be selected and set from blocks of the whole NAND memory 1. In this case, the operation relating to a read inspection and the operation relating to data writing are performed with the blocks of the NAND memory 1 as a target.

As shown in FIG. 9, when the operation starts, the timing determining unit 44 determines whether current timing corresponds to any one (or both) of the timing at which the power is turned on and a periodic inspection timing (Step S21). When the current timing does not correspond to any of the above timings (No in Step S21), the timing determining unit 44 performs the determination processing in Step S21 again.

When the current timing corresponds to any one (or both) of the timings (Yes in Step S21), the timing determining unit 44 selects one of the set inspection blocks (Step S22) and reads out the inspection pattern data in the selected inspection block to the inspection-pattern-data temporary storing unit 32 (Step S23). Then, the timing determining unit 44 determines whether the ratio of increment of the number of inverted bits included in the read out inspection pattern data, that is, a value obtained by dividing increment of the number of inverted bits from the last read inspection by a value, which is obtained by subtracting the number of inverted bits at the time of the last read inspection from the number of bits of the inspection block, exceeds a predetermined threshold (Step S24).

The threshold used in the determination processing in Step S24 may be determined based on the reference similar to the threshold used in the determination processing in Step S5 in the first embodiment. However, the threshold used in the determination processing in Step S24 is provided as a ratio instead of the number of inverted bits.

When the ratio of increment of the number of inverted bits exceeds the predetermined threshold (Yes in Step S24), the timing determining unit 44 determines whether the number of inverted bits exceeds a threshold with which the inspection cannot be performed (Step S25). The threshold with which the inspection cannot be performed is a value with which the number of inverted bits increases excessively and sufficient accuracy cannot be ensured when being used in the determination for determining timing of a read inspection of an active block.

When the number of inverted bits exceeds the threshold with which the inspection cannot be performed (Yes in Step S25), the timing determining unit 44 changes the inspection block into a free block (Step S26) and sets an active block whose erase time is older than the inspection block as a read inspection target (Step S27). When the number of inverted bits does not exceed the threshold with which the inspection cannot be performed (No in Step S25), the timing determining unit 44 records the number of inverted bits of the inspection block (Step S28) and performs the processing in Step S27. The recording destination of the number of inverted bits may be any location and may be, for example, the buffer memory 3.

Next to the processing in Step S27, the timing determining unit 44 determines whether there is an inspection block on which a read inspection has not been performed (Step S29). When there is an unexecuted inspection block (Yes in Step S29), the timing determining unit 44 moves to Step S21 and selects one inspection block from among unexecuted inspection blocks. When there is no unexecuted inspection block (No in Step S29), the read inspection performing unit 43 performs a read inspection on an active block in the processing in Step S30 to Step S35.

First, in Step S30, the read inspection performing unit 43 determines whether there is an active block as a read inspection target (Step S30). When there is an active block as a read inspection target (Yes in Step S30), the read inspection performing unit 43 selects one active block as a read inspection target (Step S31). Then, the read inspection performing unit 43 reads out data from the selected active block (Step S32) and determines whether there is a data error in the read out data (Step S33). The determination processing in Step S33 is performed by a method similar to Step S8.

When a data error occurs (Yes in Step S33), the read inspection performing unit 43 rewrites data after correction in a free block (Step S34) and excludes the selected active block from a read inspection target (Step S35). When a data error does not occur (No in Step S33), the read inspection performing unit 43 skips the processing in Step S34. After performing the processing in Step S35, the read inspection performing unit 43 performs the determination processing in Step S30.

When there is no active block as a read inspection target (No in Step S30), a read inspection of an active block ends and the timing determining unit 44 performs the determination processing in Step S21.

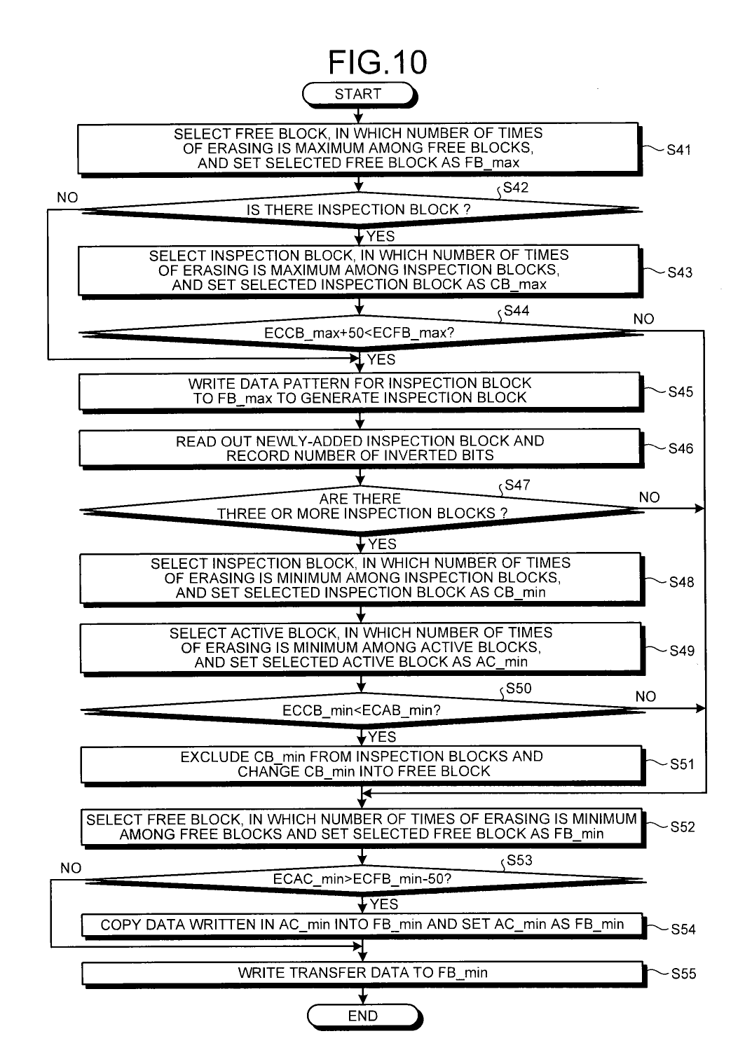

FIG. 10 is a flowchart explaining an operation relating to data writing of the SSD 300 in the second embodiment. In this embodiment, as an example, the read/write control unit 41 performs the dynamic wear leveling so that the range of the number of times of erasing falls within about 50. Moreover, as an example, the inspection block setting unit 42 basically sets three inspection data for each of the memory chips 11.

As shown in FIG. 10, first, the inspection block setting unit 42 selects a free block, in which the number of times of erasing is maximum among free blocks, and sets the selected free block as FB_max (Step S41). Then, the inspection block setting unit 42 determines whether there is an inspection block (Step S42). When there is an inspection block (Yes in Step S42), the inspection block setting unit 42 sets an inspection block, in which the number of times of erasing is maximum among inspection blocks, as CB_max (Step S43). “EC” is added to the top of the name of a block to indicate the number of times of erasing of the block. That is, for example, the number of times of erasing of an inspection block, in which the number of times of erasing is maximum, is described as “ECCB_max”.

After the processing in Step S43, the inspection block setting unit 42 determines whether a value obtained by adding 50 to the number of times of erasing ECCB_max of the inspection block, in which the number of times of erasing is maximum, is smaller than the number of times of erasing ECFB_max of the free block, in which the number of times of erasing is maximum (Step S44). When the value obtained by adding 50 to ECCB_max is smaller than ECFB_max (Yes in Step S44), the inspection block setting unit 42 sets FB_max as an inspection block and writes the inspection pattern data to the set inspection block (Step S45). At this time, the inspection block setting unit 42 records the number of inverted bits of the written inspection pattern data (Step S46). Immediately after writing the inspection pattern data to the newly-added inspection block, the number of inverted bits is zero, so that a zero value is recorded.

When there is no inspection block (No in Step S42), the inspection block setting unit 42 skips the processing in Step S43 and Step S44.

After the processing in Step S46, the inspection block setting unit 42 determines whether there are three or more inspection blocks (Step S47). When there are three or more inspection blocks (Yes in Step S47), the inspection block setting unit 42 sets an inspection block, in which the number of times of erasing is minimum among inspection blocks, as CB_min (Step S48) and sets an active block, in which the number of times of erasing is minimum among active blocks, as AC_min (Step S49).

Then, the inspection block setting unit 42 determines whether the number of times of erasing ECCB_min of the inspection block, in which the number of times of erasing is minimum, is smaller than the number of times of erasing ECAC_min of the active block, in which the number of times of erasing is minimum (Step S50). When ECCB_min is smaller than ECAC_min (Yes in Step S50), the inspection block setting unit 42 changes CB_min into a free block (Step S51). When ECCB_min is larger than ECAC_min (No in Step S50), the inspection block setting unit 42 skips the processing in Step S51.

Next, the read/write control unit 41 sets a free block, in which the number of times of erasing is minimum among free blocks, as FB_min (Step S52) and determines whether ECAC_min is larger than a value obtained by subtracting 50 from the number times of erasing ECFB_min of the free block FB_min (Step S53). When ECAC_min is larger than the value obtained by subtracting 50 from ECFB_min (Yes in Step S53), the read/write control unit 41 causes data written in AC_min to move to FB_min and sets a block that becomes a free block after the moving as FB_min (Step S54). Then, the read/write control unit 41 writes data as a write target to FB_min (Step S55) and ends the operation at the time of data writing. When ECAC_min is smaller than the value obtained by subtracting 50 from ECFB_min (No in Step S53), the read/write control unit 41 skips the processing in Step S54.

In order to set a plurality of blocks of different number of times of erasing to inspection blocks to cover the distribution of the number of times of erasing of active blocks, the inspection block setting unit 42 monitors that the number of times of erasing of a free block, in which the number of times of erasing is maximum, and adds an inspection block every time the number of times of erasing increases by a predetermined number (in this embodiment, 50). However, in the second embodiment, because the shape of the distribution of the number of times of erasing is held approximately constant due to the effect of the dynamic wear leveling, a monitoring target for determining the timing of adding an inspection block is not limited to the maximum number of times of erasing in free blocks. For example, the maximum number of times of erasing in active blocks may be a monitoring target or the maximum number of times of erasing in blocks combining free blocks and active blocks may be a monitoring target. Moreover, instead of the maximum number of times of erasing, the average number of times of erasing or the minimum number of times of erasing may be a monitoring target.

Moreover, a free block, in which the number of times of erasing is maximum, is set as a new inspection block, however, a block to be a new inspection block is not limited to a free block. For example, an active block, in which the number of times of erasing is maximum, may be set as a new inspection block. When an active block is set as an inspection block, the inspection pattern data is desirably written after transferring data in the active block to a free block.

In this manner, according to the second embodiment in the present invention, the configuration is such that the read/write control unit 41 performs the dynamic wear leveling and the inspection block setting unit 42 sets a plurality of blocks of different number of times of erasing as inspection blocks to cover the distribution of the number of times of erasing of active blocks, so that even when active blocks of different number of times of erasing are included, data loss of each of the active blocks can be efficiently prevented.

Moreover, when the number of times of erasing of a block, in which the number of times of erasing is maximum among free blocks, is larger than a value obtained by adding a predetermined number to a block, in which the number of times of erasing is maximum among inspection blocks, the inspection block setting unit 42 is configured to set the block, in which valid data is not stored and the number of times of erasing is maximum, as a new inspection block.

Furthermore, when the number of times of erasing of an inspection block, in which the number of times of erasing is minimum, is smaller than the number of times of erasing of an active block, in which the number of times of erasing is minimum, the inspection block setting unit 42 is configured to delete the inspection block, in which the number of times of erasing is minimum, from inspection blocks.

Moreover, the configuration is such that the inspection block setting unit 42 records a time set every time an inspection block is set and the timing determining unit 44 sets a block older than an inspection block, in which the ratio of increment of the number of inverted bits to the number of non-inverted bits exceeds a predetermined threshold, as a target for a read inspection, so that the number of active blocks as a read inspection target can be efficiently reduced.

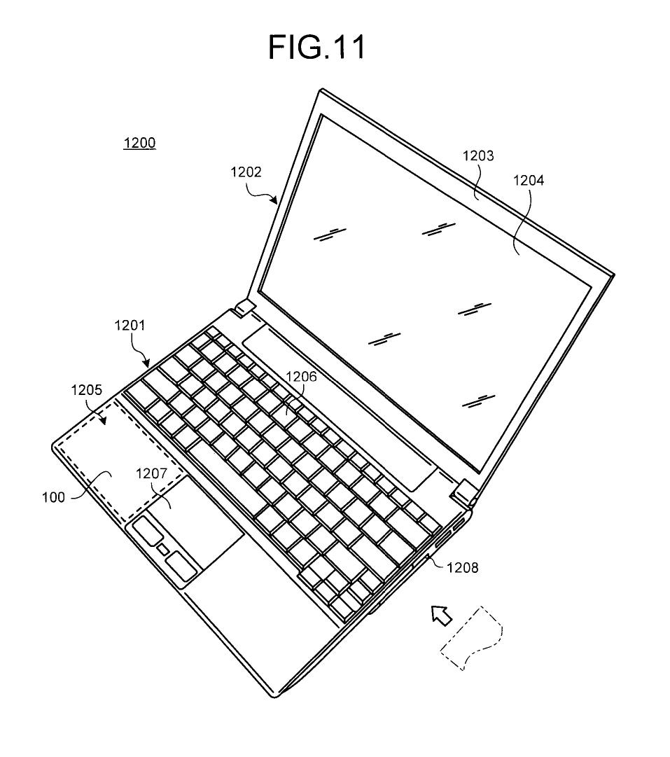

FIG. 11 is a perspective view illustrating an example of a personal computer 1200 on which the SSD 100 in the first embodiment is mounted. The personal computer 1200 includes a main body 1201 and a display unit 1202. The display unit 1202 includes a display housing 1203 and a display device 1204 accommodated in the display housing 1203.

The main body 1201 includes a chassis 1205, a keyboard 1206, and a touch pad 1207 as a pointing device. The chassis 1205 includes therein a main circuit board, an ODD (Optical Disk Device) unit, a card slot, the SSD 100, and the like.

The card slot is provided so as to be adjacent to the peripheral wall of the chassis 1205. The peripheral wall has an opening 1208 facing the card slot. A user can insert and remove an additional device into and from the card slot from outside the chassis 1205 through the opening 1208.

The SSD 100 may be used instead of a conventional HDD in the state of being mounted on the personal computer 1200 or may be used as an additional device in the state of being inserted into the card slot included in the personal computer 1200.

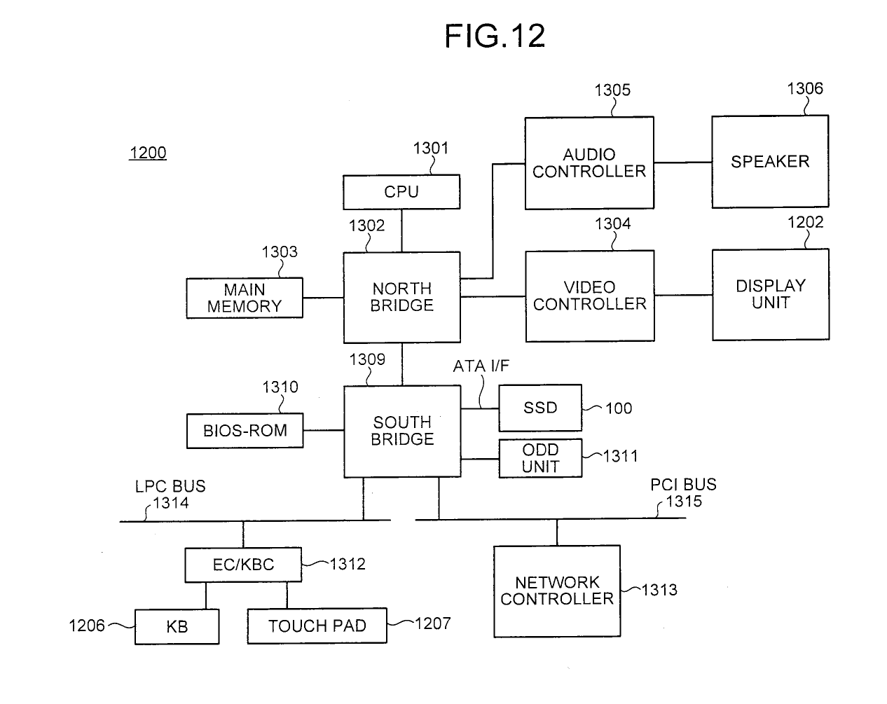

FIG. 12 illustrates a system configuration example of a personal computer on which the SSD is mounted. The personal computer 1200 includes a CPU 1301, a north bridge 1302, a main memory 1303, a video controller 1304, an audio controller 1305, a south bridge 1309, a BIOS-ROM 1310, the SSD 100, an ODD unit 1311, an embedded controller/keyboard controller IC (EC/KBC) 1312, a network controller 1313, and the like.

The CPU 1301 is a processor provided for controlling an operation of the personal computer 1200, and executes an operating system (OS) loaded from the SSD 100 onto the main memory 1303. Furthermore, when the ODD unit 1311 is capable of executing at least one of read processing and write processing on a mounted optical disk, the CPU 1301 executes the processing.

Moreover, the CPU 1301 executes a system BIOS (Basic Input Output System) stored in the BIOS-ROM 1310. The system BIOS is a program for controlling a hardware in the personal computer 1200.

The north bridge 1302 is a bridge device that connects between a local bus of the CPU 1301 and the south bridge 1309. A memory controller for performing access control of the main memory 1303 is built in the north bridge 1302.

Moreover, the north bridge 1302 has a function of executing communication with the video controller 1304 and communication with the audio controller 1305 through an AGP (Accelerated Graphics Port) bus and the like.

The main memory 1303 temporarily stores therein a program and data and functions as a work area of the CPU 1301. The main memory 1303, for example, consists of a RAM.

The video controller 1304 is a video reproduction controller for controlling the display unit 1202 used as a display monitor of the personal computer 1200.

The audio controller 1305 is an audio reproduction controller for controlling a speaker 1306 of the personal computer 1200.

The south bridge 1309 controls each device on a LPC (Low Pin Count) bus 1314 and each device on a PCI (Peripheral Component Interconnect) bus 1315. Moreover, the south bridge 1309 controls the SSD 100, which is a memory device storing various types of software and data, through the ATA interface.

The personal computer 1200 accesses the SSD 100 in sector units. A write command, a read command, a cache flush command, and the like are input to the SSD 100 through the ATA interface.

The south bridge 1309 has a function of performing access control of the BIOS-ROM 1310 and the ODD unit 1311.

The EC/KBC 1312 is a one-chip microcomputer in which an embedded controller for power management and a keyboard controller for controlling the keyboard (KB) 1206 and the touch pad 1207 are integrated.

This EC/KBC 1312 has a function of turning on/off the power of the personal computer 1200 according to an operation of a power button by a user. The network controller 1313 is, for example, a communication device that executes communication with an external network such as the Internet.

The SSD 300 explained in the second embodiment can be mounted on this personal computer 1200.

Each functional configuration unit (the read/write control unit 21, each functional configuration unit included in the read/write control unit 21, the scramble processing unit 22, the ECC circuit 23, the read/write control unit 41, and each functional configuration unit included in the read/write control unit 41) in each embodiment can be realized as any one of or a combination of hardware and software. Therefore, each functional block is explained below generally in terms of the functions thereof for clarifying that each functional block is any of these. Whether such functions are realized as hardware or software depends on a specific embodiment or a design constraint imposed on the whole system. One skilled in the art can realize these functions by various methods in each specific embodiment, and determination of such realization is within the scope of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller that performs data transfer between a nonvolatile memory including a plurality of blocks and a host apparatus, the controller comprising:
a read inspection unit that performs a read inspection for determining whether to perform, to a block in which valid data is stored among the blocks included in the nonvolatile memory, rewriting of the valid data;
an inspection block setting unit that generates an inspection block by writing inspection pattern data having a threshold as high as possible in at least one of the blocks included in the nonvolatile memory; and
a timing determining unit that determines a timing of performing the read inspection based on the number of inverted bits that occurs in the inspection pattern data written in the inspection block.

2. The controller according to claim 1, wherein the inspection block setting unit sets a block, in which the number of times of erasing is as high as possible among the blocks, as the inspection block.

3. The controller according to claim 2, wherein the inspection block setting unit sets the inspection block at every timing of performing the read inspection.

4. The controller according to claim 1, wherein the timing determining unit, when the number of inverted bits of the inspection pattern data written in the inspection block exceeds a predetermined threshold, causes the read inspection unit to perform the read inspection.

5. The controller according to claim 1, further comprising a wear leveling unit that levels the number of times of erasing between the blocks by transferring valid data stored in a first block to a second block, in which the number of times of erasing is smaller than the first block, among the blocks, wherein
the inspection block setting unit sets a plurality of blocks of different number of times of erasing as the inspection blocks to cover a distribution of the number of times of erasing of blocks in which valid data is stored.

6. The controller according to claim 5, wherein the inspection block setting unit sets a new inspection block every time a maximum number of times of erasing, an average number of times of erasing, or a minimum number of times of erasing in the blocks, blocks, in which valid data is stored among the blocks, or blocks, in which valid data is not stored among the blocks, increases by a predetermined number.

7. The controller according to claim 6, wherein the inspection block setting unit sets a block, in which the number of times of erasing is maximum among the blocks, a block, in which the number of times of erasing is maximum among blocks, in which valid data is stored, or a block, in which the number of times of erasing is maximum among blocks, in which valid data is not stored, as a new inspection block.

8. The controller according to claim 7, wherein an inspection block setting unit, when the number of times of erasing in an inspection block, in which the number of times of erasing is minimum among inspection blocks, is smaller than the number of times of erasing in a block, in which the number of times of erasing is minimum among blocks in which valid data is stored among the blocks, deletes the inspection block, in which the number of times of erasing is minimum, from inspection blocks.

9. The controller according to claim 6, wherein
the inspection block setting unit, every time an inspection block is set, records a time at which the inspection block is set, and
the timing determining unit sets a block, which is older than an inspection block in which a ratio of an increment of the number of inverted bits to the number of non-inverted bits exceeds a predetermined threshold, as a target for a read inspection.

10. The controller according to claim 1, wherein the timing determining unit counts the number of inverted bits of the inspection pattern data written in the inspection block when power is on or every time a predetermined time, during which power is on, passes.

11. The controller according to claim 5, wherein the timing determining unit counts the number of inverted bits of the inspection pattern data written in the inspection block when power is on or every time a predetermined time, during which power is on, passes.

12. The controller according to claim 1, further comprising a scramble processing unit that performs scramble processing on transfer data from the host apparatus and writes the transfer data to a block included in the nonvolatile memory, wherein
the timing determining unit instructs the scramble processing unit to exclude the inspection pattern data from a target for scramble processing.

13. The controller according to claim 5, further comprising a scramble processing unit that performs scramble processing on transfer data from the host apparatus and writes the transfer data to a block included in the nonvolatile memory, wherein
the timing determining unit instructs the scramble processing unit to exclude the inspection pattern data from a target for scramble processing.

14. A memory system comprising:
a nonvolatile memory including a plurality of blocks; and
a controller that performs data transfer between the nonvolatile memory and a host apparatus, wherein
the controller includes
a read inspection unit that performs a read inspection on a block in which valid data is stored among the blocks included in the nonvolatile memory,
an inspection block setting unit that sets an inspection block by writing inspection pattern data having a threshold as high as possible in at least one of the blocks included in the nonvolatile memory, and
a timing determining unit that determines a timing of performing the read inspection by the read inspection unit based on the number of inverted bits that occurs in the inspection pattern data written in the inspection block.

15. The memory system according to claim 14, further comprising a wear leveling unit that levels the number of times of erasing between the blocks by transferring valid data stored in a first block to a second block, in which the number of times of erasing is smaller than the first block, among the blocks, wherein
the inspection block setting unit sets a plurality of blocks of different number of times of erasing as an inspection block to cover a distribution of the number of times of erasing of blocks in which valid data is stored.

16. The memory system according to claim 14, further comprising a scramble processing unit that performs scramble processing on transfer data from the host apparatus and writes the transfer data to a block included in the nonvolatile memory, wherein
the timing determining unit instructs the scramble processing unit to exclude the inspection pattern data from a target for scramble processing.

17. An inspection method of a nonvolatile memory including a plurality of blocks, the method comprising:
designating at least one of the blocks included in the nonvolatile memory as an inspection block;
writing inspection pattern data having a threshold as high as possible in the inspection block;
determining an execution timing of inspection based on the number of inverted bits occurred in the inspection pattern data written in the inspection block; and
performing a read inspection on a block, in which valid data is stored, among the blocks included in the nonvolatile memory at determined execution timing.

18. The inspection method according to claim 17, further comprising leveling the number of times of erasing between the blocks by transferring valid data stored in a first block to a second block, in which the number of times of erasing is smaller than the first block, among the blocks, wherein
a plurality of blocks of different number of times of erasing is designated as an inspection block to cover a distribution of the number of times of erasing of blocks in which valid data is stored.

19. The inspection method according to claim 17, further comprising:
performing scramble processing on transfer data from a host apparatus and writing the transfer data to a block included in the nonvolatile memory; and
excluding the inspection pattern data from a target for scramble processing.
